(19) United States
(12) Patent Application Publication
(10) Pub. No.: US 2010/0265803 A1
(43) Pub. Date: Oct. 21, 2010

(54) AID APPARATUS FOR ENHANCING SLEEPING AND AWAKENING

(76) Inventor: Wen-Sung LEE, Taichung City (TW)

Correspondence Address: Chien-Hui Su, P. O. Box 70-121 Taichung, Taichung City, 40899, TW

(21) Appl. No.: 12/426,286

(22) Filed: Apr. 20, 2009

(51) Int. Cl. G04C 21/16

(52) U.S. Cl. 368/245; 368/256

(57) ABSTRACT

An aid device for enhancing sleeping and awakening includes an illuminant device and an audio device. A control unit is electrically connected to the illuminant device and the audio device. The control unit includes an illuminant gradual transformation module, an audio gradual transformation module, and a time setting module. The illuminant gradual transformation module is controlled the illuminant device. The audio gradual transformation module is controlled the audio device. The time setting module is controlled an active time of the illuminant device and an active time of the audio device. A control interface is electrically connected to the control unit. The control interface is provided for inputting a data to the control unit.

### BACKGROUND OF THE INVENTION

1. Field of the Invention

The present invention relates to an aid apparatus, and more particularly to an aid apparatus for gradually enhancing sleeping and awakening.

2. Description of Related Art

Based on a human natural rhythm, a human mood is periodic changed due to a shift of day and night. During in the night, the light is usually dim and the noise is less. The human mood is changed from an excited and spirited mood of daytime to a peaceful and relaxed mood of night time. A gentle light and a soft music for relaxing the human mood, it can relax a sense of sight and hearing of a human body for naturally releasing stress of daily working. Furthermore, a mental fatigue is cured due to the gentle light and soft music. The light and the music with respect to the sleep are important factors for changing human mood.

Accordingly, it is considered effective to control the light and the music for making the person in the state of relaxation. The present invention has arisen to enhance sleeping and awakening.

### SUMMARY OF THE INVENTION

The main objective of the present invention is to provide an improved aid device for enhancing sleeping and awakening.

To achieve the objective, an aid device for enhancing sleeping and awakening in accordance with the present invention comprises an illuminant device and an audio device. A control unit is electrically connected to the illuminant device and the audio device. The control unit includes an illuminant gradual transformation module, an audio gradual transformation module, and a time setting module. The illuminant gradual transformation module is controlled the illuminant device to gradually transform a light of the illuminant device for enhancing sleeping/awakening. The audio gradual transformation module is controlled the audio device to gradually transform a volume of the audio device for enhancing sleeping/awakening. The time setting module is controlled an active time of the illuminant device and an active time of the audio device. A control interface is electrically connected to the control unit. The control interface is provided for inputting a data to the control unit for setting the illuminant gradual transformation module, the audio gradual transformation module and the time setting module.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of an aid device for enhancing sleeping and awakening in accordance with the present invention;

FIG. 2 is an exploded perspective view of the aid device for enhancing sleeping and awakening in accordance with the present invention;

FIG. 3 is an assembled perspective view of the aid device for enhancing sleeping and awakening in accordance with the present invention;

FIG. 4 is a cross-sectional view of the aid device for enhancing sleeping and awakening in accordance with the present invention taken along A-A line in FIG. 3; and

FIGS. 5-6 are operational views of the aid device for enhancing sleeping and awakening in accordance with the present invention.

### DETAILED DESCRIPTION OF THE INVENTION

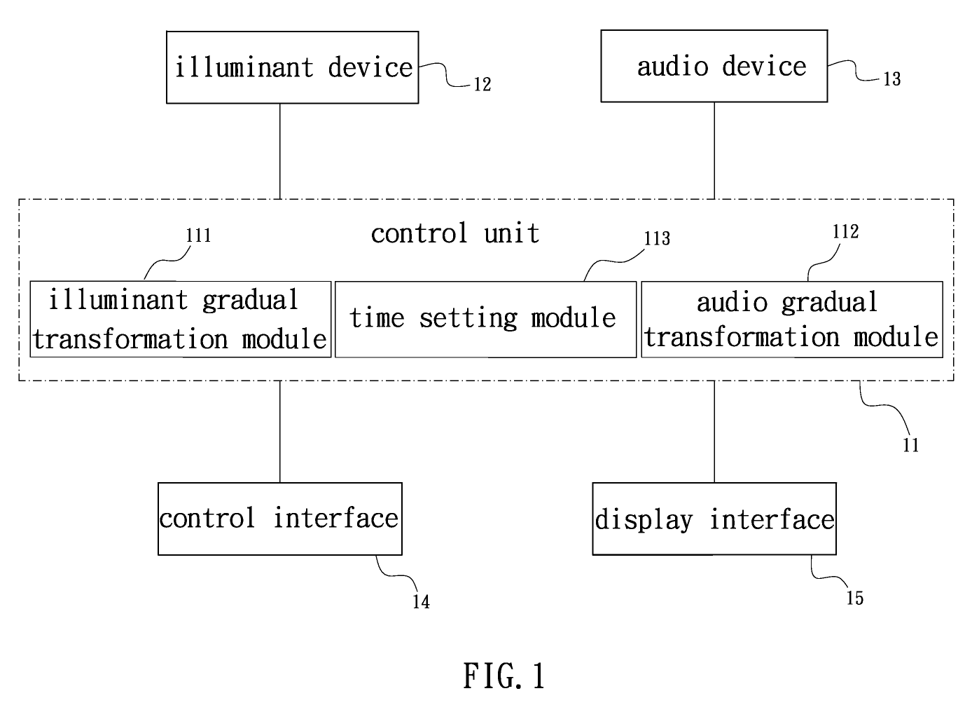

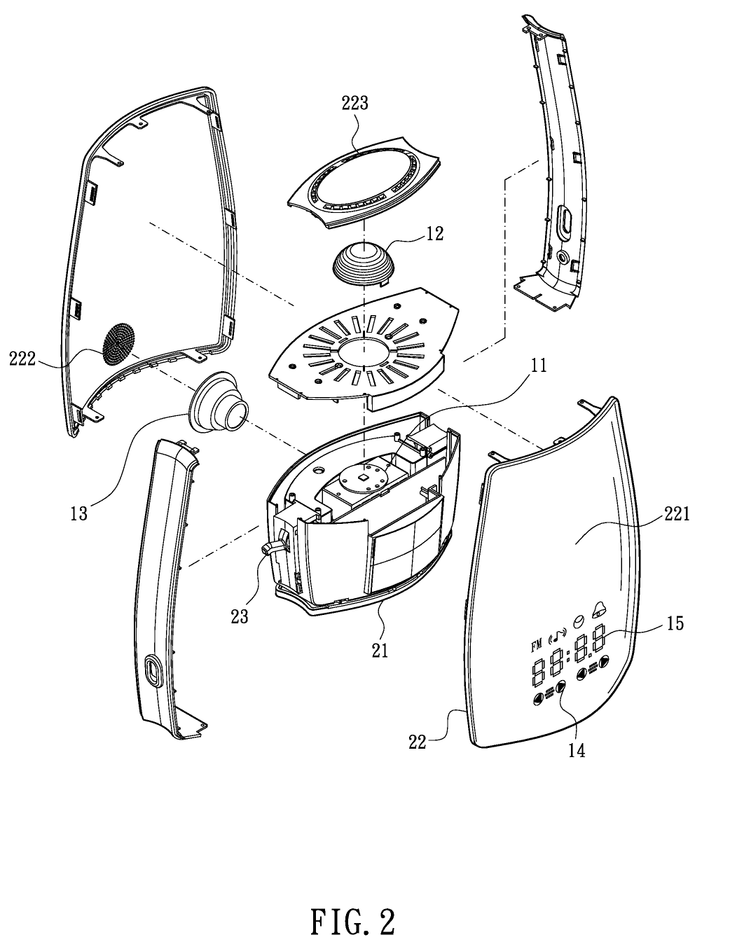

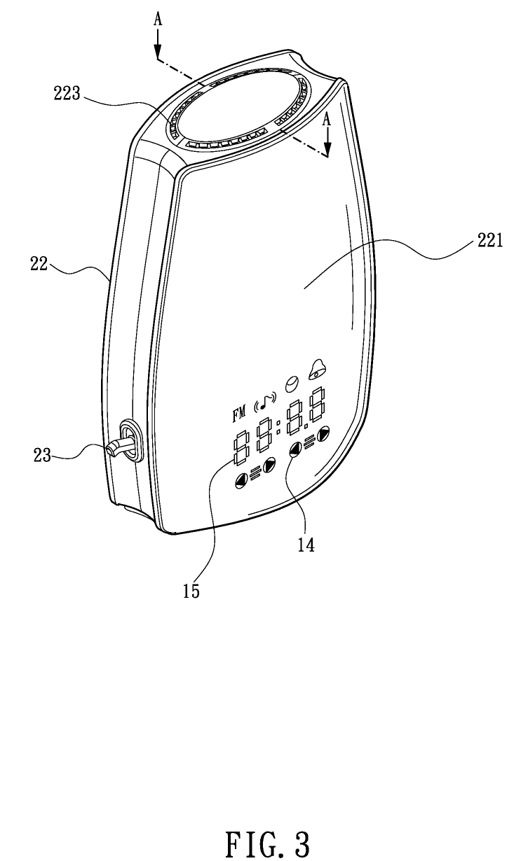

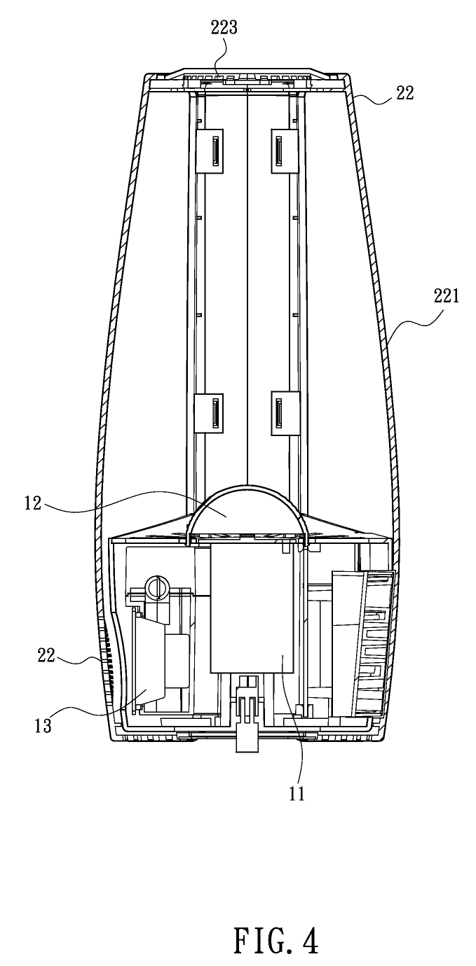

Referring to the drawings and initially to FIGS. 1-4, an aid apparatus for enhancing sleeping and awakening in accordance with the present invention comprises a control unit 11, an illuminant device 12 electrically connected to the control unit 11, an audio device 13 electrically connected to the control unit 11.

The control unit 11 is received in a base 21. The illuminant device 12 is arranged on the control unit 11. In the preferred embodiment of the present invention, the illuminant device 12 is a blue light emitting diode. The audio device 13 is laterally mounted on the base 21. A housing 22 is mounted on the base 21 for preventing the control unit 11, the illuminant device 12, and the audio device 13 from exposing. The housing 22 includes a front casing (not numbered) and a rear casing (not numbered) laterally respectively mounted on two end of the base 21. The rear casing has a grille 222 corresponding to the audio device 13. The housing 22 includes two side casings (not numbered) respectively laterally mounted on two sides of the base 21. The housing 22 has a top casing (not numbered) disposed on a top thereof. The top casing has a radiator grille 223 corresponding to the illuminant device 12 for radiating a heat produced by the illuminant device 12. The illuminant device 12 is provided for illuminating lights. The audio device 13 is provided for tuning music. The control unit 11 includes an illuminant gradual transformation module 111, an audio gradual transformation module 112, and a time setting module 113. The illuminant gradual transformation module 111 is provided for controlling the illuminant device 12 to gradually reduce/increase a light of the illuminant device 12 for enhancing a human sleeping/awakening. The audio gradual transformation module 112 is provided for controlling the audio device 13 to gradually reduce/increase a volume of the music of the audio device 13 for enhancing a human sleeping/awakening. The time setting module 113 is provided for controlling an active time of the illuminant device 12 and an active time of the audio device 13. A control interface 14 is disposed on the front casing of the housing 22. The control interface 14 is electrically connected to the control unit 11. The control interface 14 is provided for inputting a data to the control unit 11 for setting the illuminant gradual transformation module 111, the audio gradual transformation module 112 and the time setting module 113. A display interface 15 is disposed on the front casing. The display interface 15 is electrically connected to the control unit 11. The display interface 15 is provided for showing the data inputted by the control interface 14, a status of the illuminant device 12, and a status of the audio device 13. Each of the front casing and the rear casing of the housing 22 has a light penetrable surface 221 disposed thereon for allowing the light of the illuminant device 12 for passing through the light penetrable surface 221. A switch 23 is mounted on the side of the base 21. The switch 23 is electrically connected to the control unit 11. The switch 23 is provided for quickly switching on/off the illuminant device 12 and the audio device 13 without setting the control unit 11.

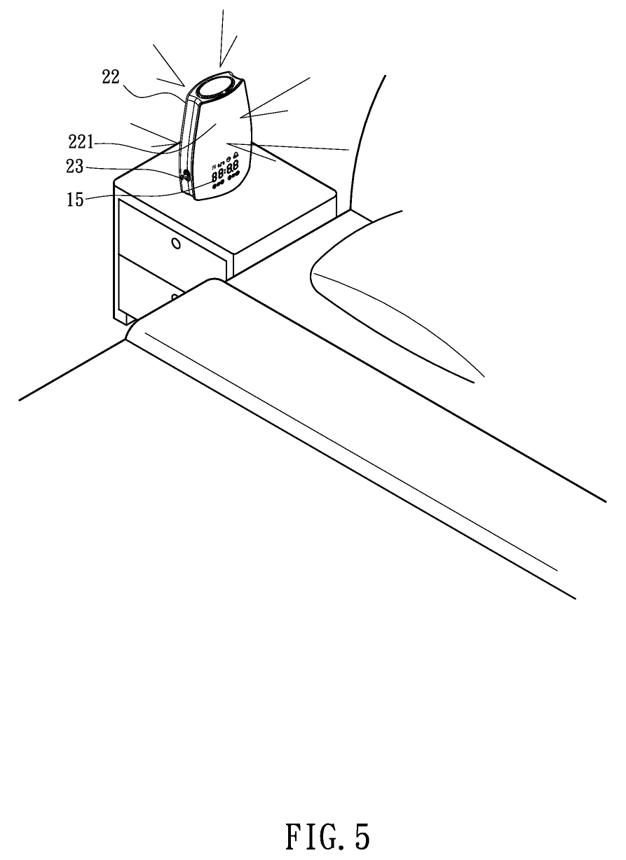

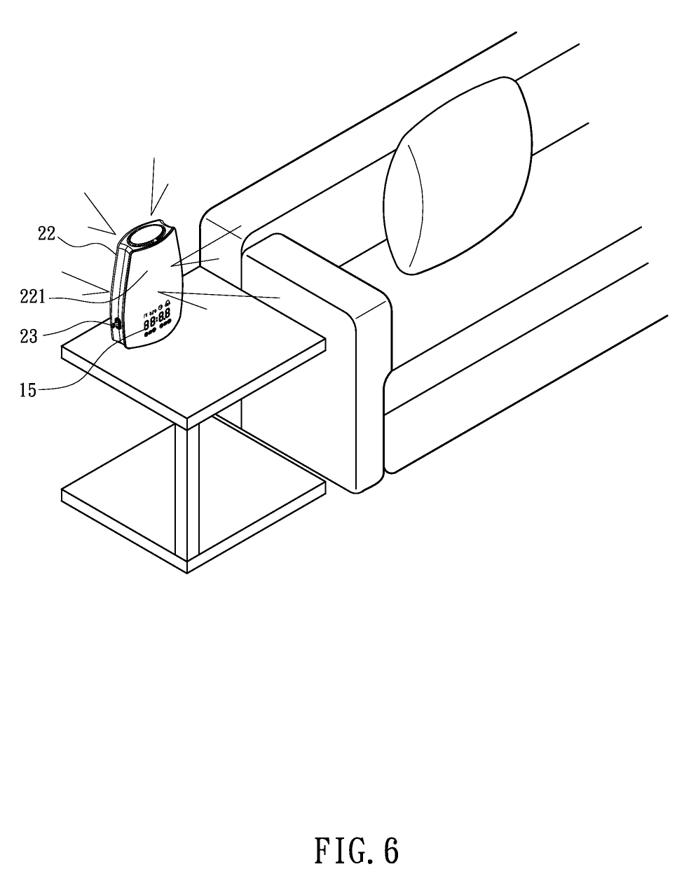

With reference FIGS. 5-6, a user can operate the switch 23 for quickly switching on/off the illuminant device 12 and the audio device 13 such that the illuminant device 12 is provided for a night light or a table light. The user can operate the control interface 14 for setting the time setting module 113, such as the active time of the illuminant device 12 and the audio device 13, a switch on/off time, and a total active period. (For example, the active time is set at 10 o'clock and the total active period is 90 minutes. The illuminant device 12 and the audio device 13 are switched on at 10 o'clock. The light is continuously gradually transformed and the volume is continuously gradually reduced/increased during 90 minutes.) In a specific time set by the time setting module 113, the illuminant device 12 is controlled by the illuminant gradual transformation module 111 for providing a light which is gently and gradually transformed from a bright/dim light to a dim/bright light for enhancing sleeping/awakening. The illuminant device 12 provides a blue light. Based on a recently research in Japan, the blue light can effectively relax a mood of human and release a stress of working. In a specific time set by the time setting module 113, the audio device 13 is controlled by the audio gradual transformation module 112 for providing a music which is softly and gradually reduced/increased from a loud/faint music to a faint/loud music for enhancing sleeping/awakening. A human brain can be peacefully fallen asleep or be naturally awakened. Furthermore, the aid device in accordance with the present invention can be provided for an alarm clock. The user can operate the control interface 14 for setting the time setting module 113 such that the audio device 13 controlled by the audio gradual transformation module 112 is provided an alarm music for softly and gradually increased the volume of the music for awakening the user.

Although the invention has been explained in relation to its preferred embodiment, it is to be understood that many other possible modifications and variations can be made without departing from the spirit and scope of the invention as hereinafter claimed.

What is claimed is:

1. An aid apparatus for enhancing sleeping and awakening:
an illuminant device provided for illuminating;
a control unit, the control unit electrically connected to the illuminant device, the control unit including an illuminant gradual transformation module and a time setting module, the illuminant gradual transformation module provided for controlling the illuminant device to gradually transform a light of the illuminant device for enhancing sleeping/awakening, the time setting module provided for controlling an active time of the illuminant device; and
a control interface electrically connected to the control unit, the control interface provided for inputting a data to the control unit for setting the illuminant gradual transformation module and the time setting module;
wherein when in a specific time set by the time setting module, the illuminant device is controlled by the illuminant gradual transformation module for providing a light which is gently transformed for enhancing sleeping/awakening.

2. The aid apparatus for enhancing sleeping and awakening as claimed in claim 1 further comprising a display interface electrically connected to the control unit, the display interface showed the data inputted by the control interface and a status of the illuminant device.

3. The aid apparatus for enhancing sleeping and awakening as claimed in claim 1 further comprising a base for receiving the illuminant device and the control unit, and a housing mounted on the base, the control interface disposed on the housing, the housing having a light penetrable surface disposed thereon for allowing the light of the illuminant device for passing through the light penetrable surface.

4. The aid apparatus for enhancing sleeping and awakening as claimed in claim 3, wherein the housing has a radiator grille disposed thereon for radiating a heat produced by the illuminant device.

5. The aid apparatus for enhancing sleeping and awakening as claimed in claim 1, wherein the illuminant device is a blue light emitting diode.

6. The aid apparatus for enhancing sleeping and awakening as claimed in claim 1 further comprising a switch for quickly switching on/off the illuminant device without setting the control unit.

7. An aid apparatus for enhancing sleeping and awakening:
an audio device provided for tuning;
a control unit, the control unit electrically connected to the audio device, the control unit including an audio gradual transformation module and a time setting module, the audio gradual transformation module provided for controlling the audio device to gradually transform a volume of the audio device for enhancing sleeping/awakening, the time setting module provided for controlling an active time of the audio device; and
a control interface electrically connected to the control unit, the control interface provided for inputting a data to the control unit for setting the audio gradual transformation module and the time setting module;
wherein when in a specific time set by the time setting module, the audio device is controlled by the audio gradual transformation module for providing a volume which is softly reduced/increased for enhancing sleeping/awakening.

8. The aid apparatus for enhancing sleeping and awakening as claimed in claim 7 further comprising a display interface electrically connected to the control unit, the display interface showed the data inputted by the control interface and a status of the audio device.

9. The aid apparatus for enhancing sleeping and awakening as claimed in claim 7 further comprising a base for receiving the audio device and the control unit, and a housing mounted on the base, the control interface disposed on the housing, the housing having a grille disposed thereon.

10. The aid apparatus for enhancing sleeping and awakening as claimed in claim 7 further comprising a switch for quickly switching on/off the audio device without setting the control unit.

11. An aid apparatus for enhancing sleeping and awakening:
an illuminant device provided for illuminating;
an audio device provided for tuning;
a control unit, the control unit electrically connected to the illuminant device and the audio device, the control unit including an illuminant gradual transformation module, an audio gradual transformation module, and a time setting module, the illuminant gradual transformation module provided for controlling the illuminant device to gradually transform a light of the illuminant device for enhancing sleeping/awakening, the audio gradual transformation module provided for controlling the audio device to gradually transform a volume of the audio device for enhancing sleeping/awakening, the time setting module provided for controlling an active time of the illuminant device and an active time of the audio device; and
a control interface electrically connected to the control unit, the control interface provided for inputting a data to the control unit for setting the illuminant gradual transformation module, the audio gradual transformation module and the time setting module;
wherein when in a specific time set by the time setting module, the illuminant device is controlled by the illuminant gradual transformation module for providing a light which is gently transformed for enhancing sleeping/awakening;
wherein when in a specific time set by the time setting module, the audio device is controlled by the audio gradual transformation module for providing a volume which is softly reduced/increased for enhancing sleeping/awakening.

12. The aid apparatus for enhancing sleeping and awakening as claimed in claim 11 further comprising a display interface electrically connected to the control unit, the display interface showed the data inputted by the control interface, a status of the illuminant device, and a status of the audio device.

13. The aid apparatus for enhancing sleeping and awakening as claimed in claim 11 further comprising a base for receiving the illuminant device, the audio device, and the control unit, and a housing mounted on the base, the control interface disposed on the housing, the housing having a light penetrable surface disposed thereon for allowing the light of the illuminant device for passing through the light penetrable surface, the housing having a grille disposed thereon.

14. The aid apparatus for enhancing sleeping and awakening as claimed in claim 13, wherein the housing has a radiator grille disposed thereon for radiating a heat produced by the illuminant device.

15. The aid apparatus for enhancing sleeping and awakening as claimed in claim 11, wherein the illuminant device is a blue light emitting diode.

16. The aid apparatus for enhancing sleeping and awakening as claimed in claim 11 further comprising a switch for quickly switching on/off the illuminant device and the audio device without setting the control unit.
